(19) United States
(12) Patent Application Publication
(10) Pub. No.: US 2026/0138836 A1
(43) Pub. Date: May 21, 2026

(54) ARTICLE LOADING SYSTEM

(71) Applicant: BHARAT FORGE LIMITED, Pune (IN)

(72) Inventors: BABASAHEB NEELKANTH KALYANI, Pune (IN); JITENDRA MADHUSUDAN PATIL, Pune (IN); SANJAY VASANT PATIL, Pune (IN); PRITAM SOMESHWAR DONGARKAR, Pune (IN); AKSHAY SOMNATH DHONDE, Pune (IN); AKASH PUSHPANAND PANDEY, Pune (IN)

(21) Appl. No.: 19/391,142

(22) Filed: Nov. 17, 2025

(30) Foreign Application Priority Data
Nov. 19, 2024 (IN) 202421089492

(51) Int. Cl. B65G 51/28; B65G 65/16

(52) U.S. Cl. CPC B65G 51/28; B65G 65/16

(57) ABSTRACT

An article loading system that includes a double parallelogram mechanism provided to obtain a circular motion and a linear motion. Further, a crank pin is provided to drive the double parallelogram mechanism. Furthermore, the circular motion and the linear motion of the double parallelogram mechanism is obtained in a single cranking motion of the crank pin. Moreover, the cranking motion of the crank pin is facilitated by a pinion connected to the crank pin. Further, a tray is provided to hold an article. Further, the tray is attached to the double parallelogram mechanism. Additionally, an actuator is provided to rotate the pinion. Further, the rotation of the pinion facilitates the cranking motion of the crank pin to drive the double parallelogram mechanism.

### CROSS-REFERENCE TO RELATED APPLICATIONS AND PRIORITY

The present application claims no priority from any of the patent application(s).

### TECHNICAL FIELD

The present invention relates to the field of an article loading system. More particularly, the present invention relates to a double parallelogram mechanism for the article loading system.

### BACKGROUND

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Loading platforms for lifting or displacing a product are widely used in various industrial applications. Further, a linkage mechanism for driving such loading platforms is designed and developed considering the factors like location, space, power source, and type of application. There are various industrial segments like logistic industry, warehouse material handling, material feeding in manufacturing industry, automated assembly lines, and many others where the loading platform with linkage mechanism is used. Additionally, there are various configurations of the linkage mechanism are formed with respect to the specific operational requirement. These linkage mechanisms are fixedly or detachably attached to the loading platform carrying the product. Moreover, the operation of such linkage mechanism is performed by an actuator which can be hydraulically, or pneumatically, or electrically powered.

In one of the configurations of conventional linkage mechanism, a parallelogram linkage mechanism is used for driving the loading platform carrying the product. Further, the parallelogram linkage mechanism is also known as a four-bar mechanism. In the combination of the conventional parallelogram mechanism with the loading platform, one link of the linkage mechanism is attached to the loading platform, and the opposite like of the same is attached to an actuator. Further, the actuator operates the parallelogram linkage mechanism causing movement of the loading platform from initial position to final position forming a circular trajectory. More specifically, the conventional mechanism only allows the aligning of the loading platform with a space where the product is to be unloaded.

In such conventional mechanism, the movement of the loading platform is restricted only up to a circular motion. Also, the circular motion achieved by the conventional mechanism fails to facilitate the unloading operation of the product from the loading platform. More specifically, the conventional parallelogram linkage mechanism fails to facilitate a linear motion of the loading platform followed after completion of the circular motion. Additionally, the conventional linkage mechanisms include heavier links which affects operational efficiency and maintenance of the entire mechanism. Also, the coupling of the actuator with any one of the links of the conventional linkage mechanism is complex and causes failure during transfer of power from the actuator to the parallelogram linkage mechanism.

In light of the above stated discussion, there exists a need of an improved parallelogram linkage mechanism for driving a loading platform to overcome at least one of the above stated problems.

### SUMMARY

Before the present system (or apparatus) and method, and its components are described, it is to be understood that this disclosure is not limited to the system and its arrangement as described, as there can be multiple possible embodiments which are not expressly illustrated in the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

In one non-limiting example embodiment, an article loading system is disclosed. Further, the article loading system includes a double parallelogram mechanism provided to obtain a circular motion, and subsequently a linear motion. Further, the double parallelogram mechanism may include a first set of links, and a second set of links. Furthermore, a crank pin is provided to drive the double parallelogram mechanism. Further, the circular motion, and subsequently the linear motion of the double parallelogram mechanism is obtained in a single cranking motion of the crank pin. Furthermore, the cranking motion of the crank pin is facilitated by a pinion connected to the crank pin. Further, a tray is provided to hold an article. Further, the tray is attached to at least one link of the first set of links. Furthermore, an actuator is provided to rotate the pinion. Moreover, the rotation of the pinion facilitates the cranking motion of the crank pin to drive the double parallelogram mechanism.

In another example embodiment, the double parallelogram mechanism may be provided to load the article within the tray into a hollow tube. Further, the article may be loaded inline with an axis of the hollow tube.

In yet another example embodiment, the double parallelogram mechanism is configured to obtain the circular motion in first stage of the cranking motion to align a central axis of the tray with the axis of the hollow tube, following a circular trajectory.

In yet another example embodiment, the double parallelogram mechanism is configured to obtain the linear motion in second stage of the cranking motion to linearly move the tray inline with the axis of the hollow tube, following a linear trajectory.

In yet another example embodiment, the first set of links may include a first binary link, a second binary link, a third binary link, and a fourth binary link forming a parallelogram mechanism. Further, each of the first binary link, the second binary link, the third binary link, and the fourth binary link are mechanically connected to each other.

In yet another example embodiment, the second set of links may include a first curved link, a second curved link, the crank pin as third curved link, and a ground link. Further, the ground link corresponds to a link formed by fix ends of the first curved link, the second curved link, and the crank pin respectively.

In yet another example embodiment, the tray may be coupled to the second binary link of the first set of links.

In yet another example embodiment, the fix ends of the first curved link, the second curved link may be connected by a fifth link.

In yet another example embodiment, the pinion may be placed at a centre position between the first curved link, and the second curved link. Further, the centre position of the pinion may be provided at an equal offset distance from the first curved link, and the second curved link.

In yet another example embodiment, the first curved link may be connected to the first binary link. Further, the second curved link may be connected to the fourth binary link. Further, at least one end of the crank pin as the third curved link may be connected to the third binary link. Furthermore, at least one end of the crank pin may be provided with the pinion provided to drive the double parallelogram mechanism.

In yet another example embodiment, the pinion may be rotated in clockwise, and anti-clockwise direction by the actuator. Further, the pinion rotates in the clockwise direction on forward movement (F) of the actuator. Furthermore, the pinion may rotate in the anti-clockwise direction on rearward movement (R) of the actuator. Further, the rotation of the pinion in the clockwise, and anti-clockwise direction may facilitate the cranking motion of the crank pin in the clockwise, and anti-clockwise direction.

In yet another example embodiment, the actuator may include a rack. Further, the rack may be provided to engage with the pinion connected to the crank pin. Furthermore, the forward movement (F), and the rearward movement (R) of the actuator may be transferred by the rack to the pinion. Further, the pinion (108) may be rotated in the clockwise, and the anti-clockwise direction with the forward movement (F), and the rearward movement (R) respectively.

In yet another example embodiment, the actuator may include at least one of hydraulic actuator, pneumatic actuator, electrical actuator, or any combination thereof.

In yet another example embodiment, the tray may include a conical ring at front portion. Further, the conical ring may be adapted to be placed securely against a conical opening of the hollow tube. Furthermore, the linear motion of the tray may facilitate concentric securing of the conical ring with the axis of the hollow tube at the conical opening.

In yet another example embodiment, a ramming actuator may be provided at the rear portion of the tray. Further, the rear portion of the tray may be provided with a stopper. Furthermore, the stopper may be provided to hold the article placed within the tray from rear side. Further, the ramming actuator may be provided to load the article to the hollow tube by displacing the stopper.

### BRIEF DESCRIPTION OF FIGURES

Having thus described the disclosure in general terms, references will now be made to the accompanying figures, wherein:

FIG. 1 illustrates a first isometric views (1000) of an article loading system (100), in accordance with various embodiments of the present disclosure;

FIG. 2 illustrates a second isometric view (1000a) of the article loading system (100), in accordance with various embodiments of the present disclosure;

FIG. 3 illustrates a top view (2000) of the article loading system (100), in accordance with various embodiments of the present disclosure;

FIG. 4 illustrates a bottom view (2000a) of the article loading system (100), in accordance with various embodiments of the present disclosure;

FIG. 5 illustrates an alignment position (3000) of the article loading system (100), in accordance with various embodiments of the present disclosure; and

FIG. 6 illustrates a loading position (4000) of the article loading system (100), in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in more detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of embodiments of the present description. As used herein, the term “and/or” includes any and all combinations of one or more of the associated listed items. Throughout the present disclosure, the expression “at least one of a, b and c” indicates only a, only b, only c, both a and b, both a and c, both b and c, all of a, b, and c, or variations thereof.

The subject matter of the present disclosure may include various modifications and various embodiments, and example embodiments will be illustrated in the drawings and described in more detail in the detailed description. Effects and features of the subject matter of the present disclosure, and implementation methods therefor will become clear with reference to the embodiments described herein below together with the drawings. The subject matter of the present disclosure may, however, be embodied in many different forms and should not be construed as limited to the embodiments set forth herein.

Hereinafter, embodiments of the present disclosure will be described in more detail with reference to the accompanying drawings. The same or corresponding elements will be denoted by the same reference numerals, and thus, redundant description thereof will not be repeated.

It will be understood that although the terms “first,” “second,” etc. may be used herein to describe various elements, these elements should not be limited by these terms. These terms are only used to distinguish one element from another.

An expression used in the singular may also encompasses the expression of the plural, unless it has a clearly different meaning in the context.

In the following embodiments, it is to be understood that the terms such as “including,” “includes,” “having,” “comprises,” and “comprising,” are intended to indicate the existence of the features or elements disclosed in the specification, and are not intended to preclude the possibility that one or more other features or elements may exist or may be added.

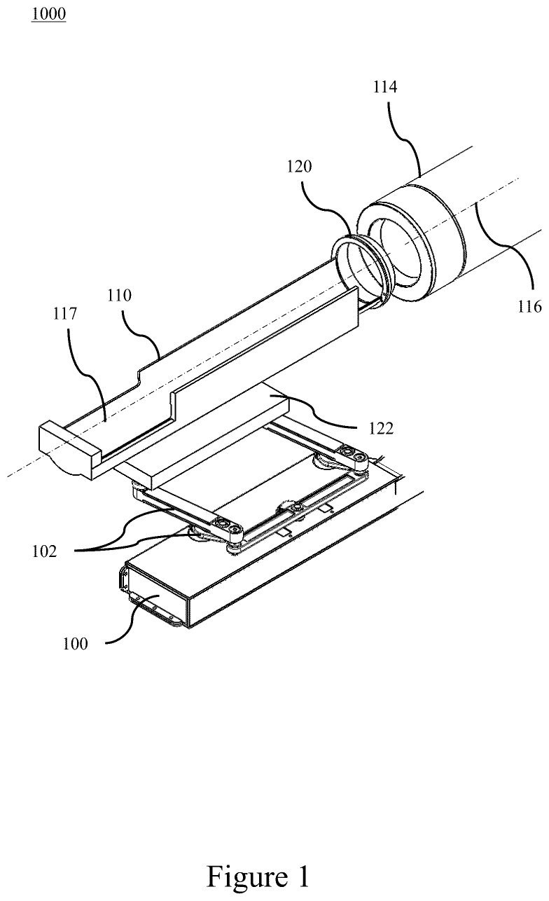

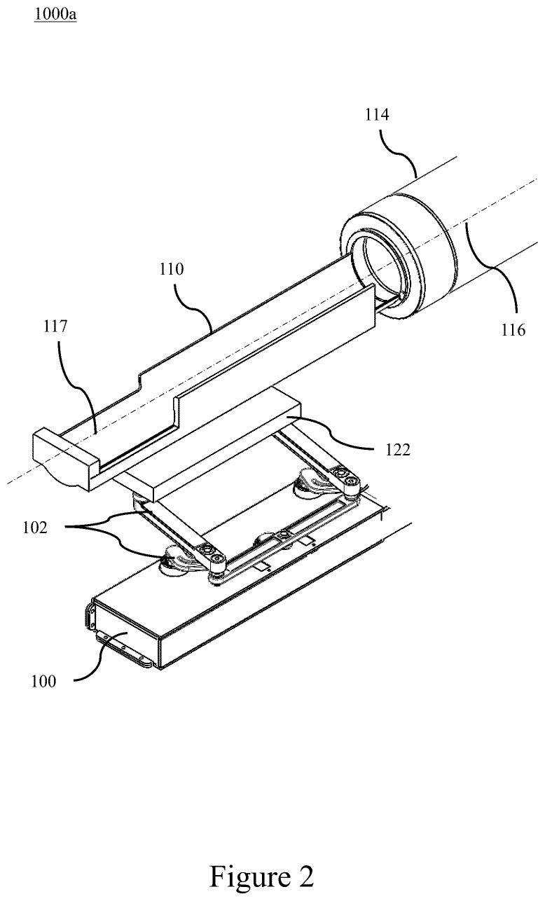

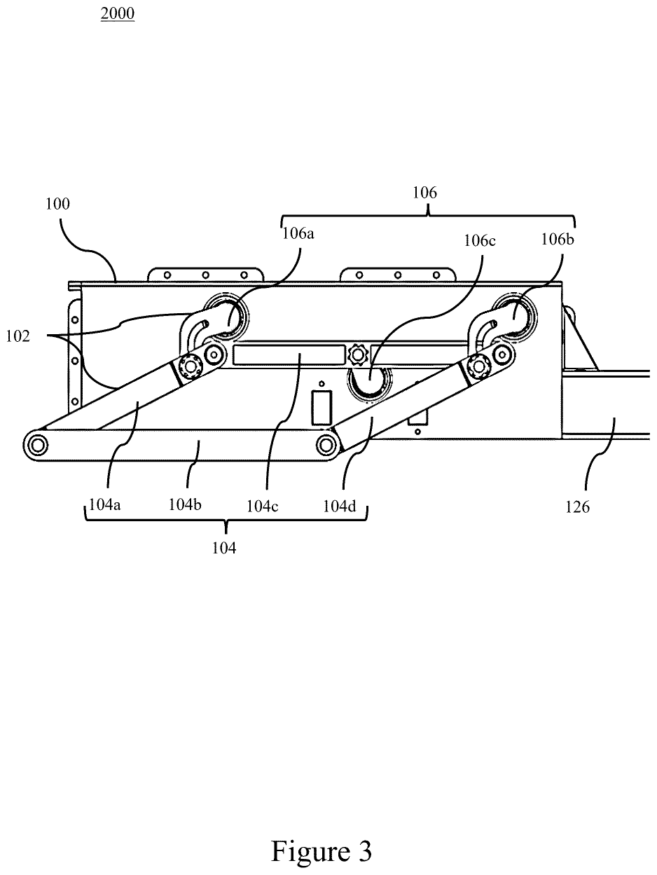

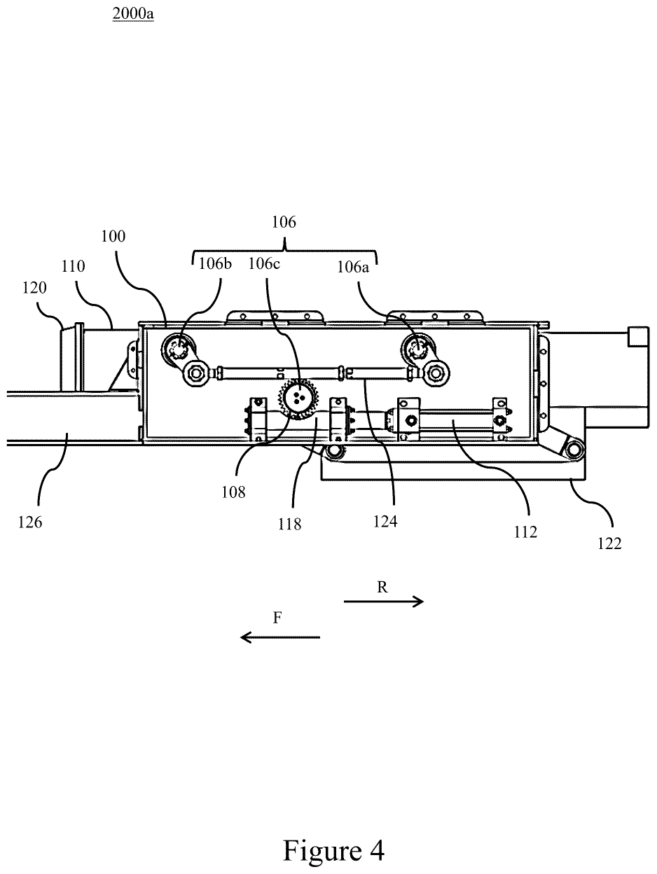

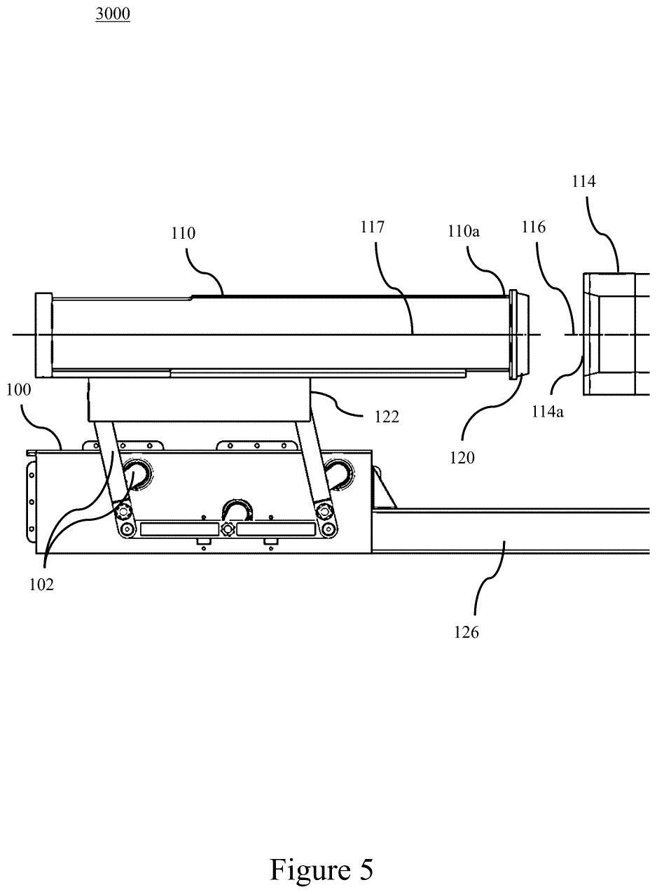

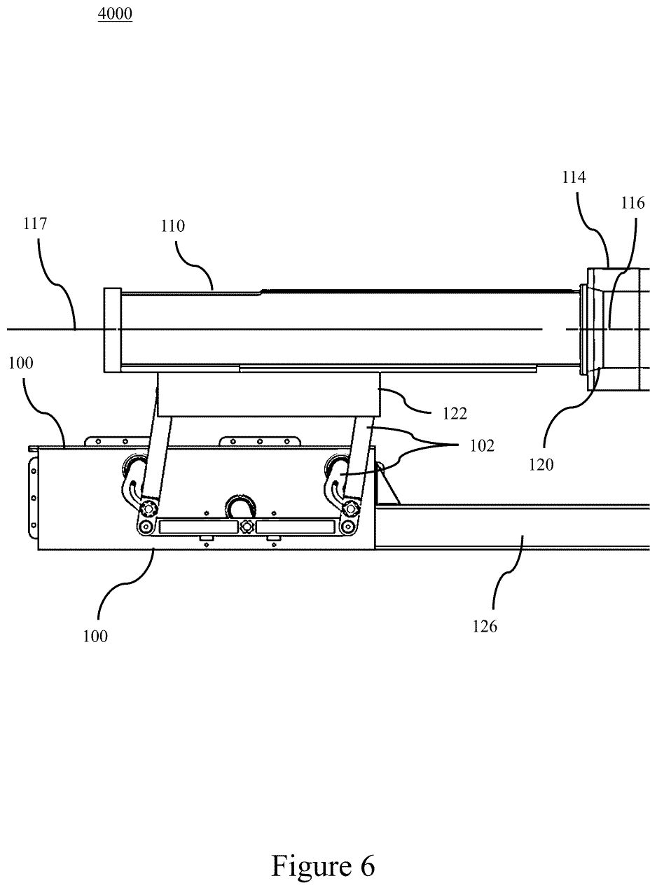

FIG. 1 illustrates a first isometric views (1000) of an article loading system (100), in accordance with various embodiments of the present disclosure. FIG. 2 illustrates a second isometric view (1000a) of the article loading system (100), in accordance with various embodiments of the present disclosure. FIG. 3 illustrates a top view (2000) of the article loading system (100), in accordance with various embodiments of the present disclosure. FIG. 4 illustrates a bottom view (2000a) of the article loading system (100), in accordance with various embodiments of the present disclosure. FIG. 5 illustrates an alignment position (3000) of the article loading system (100), in accordance with various embodiments of the present disclosure. FIG. 6 illustrates a loading position (4000) of the article loading system (100), in accordance with various embodiments of the present disclosure.

In an embodiment, the article loading system (100) includes a double parallelogram mechanism (102) which is provided to obtain a circular motion, and subsequently a linear motion. In addition, the double parallelogram mechanism (102) includes a first set of links (104), and a second set of links (106). Further, a crank pin (106c) is provided to drive the double parallelogram mechanism (102). Furthermore, the circular motion and subsequently the linear motion of the double parallelogram mechanism (102) is obtained in a single cranking motion of the crank pin (106c). Moreover, the cranking motion of the crank pin (106c) is facilitated by a pinion (108) connected to the crank pin (106c). Also, a tray (110) is provided to hold an article. In addition, the tray (110) is attached to at least one of the first set of links (104). Further, an actuator (112) is provided to rotate the pinion (108). Furthermore, the rotation of the pinion (108) facilitates the cranking motion of the crank pin (106c) to drive the double parallelogram mechanism (102). In some examples, the single cranking motion may refer to rotation of the crank pin (106c) from one position to another position which completely drives the double parallelogram mechanism (102) from one position to another position and vice-versa.

In some embodiments, the article loading system (100) may be configured to load the article within a hollow tube (114). Further, the hollow tube (114) may include a cross-section at least one of circular, rectangular, and triangular cross-section.

Furthermore, the article may be loaded within the hollow tube (114) along with an axis (116) of the hollow tube (114). In one example, the article may include a shape but not limited to cylindrical, rectangular, triangular, conical, ogive, wedge-shaped, hemispherical, or any combination thereof. In some examples, the article may include payload, ball, parcel, dart, spear, cannonball, firework, torpedo, shell, projectile, missile, grenade, ammunition, and the like. Furthermore, the article loading system (100) may be mounted on a platform (126). Further, the platform (126) may be a stationary platform, or a mobile platform, or a combination thereof. Moreover, the article loading system (100) may be attached to the platform (126) in at least one of detachable, or integrated form. Further, the hollow tube (114) and the platform (126) may be coupled together in at least one of detachable, or integrated form. In some examples, the platform (126) may be attached to a stationary structure, vehicle, artillery, and the like.

Now referring to FIG. 5, and 6, the double parallelogram mechanism (102) may be configured to follow a circular trajectory and subsequently a linear trajectory while loading the article to the hollow tube (114). Further, the circular motion of the double parallelogram mechanism (102) in first stage of the cranking motion may lead to follow the circular trajectory. Furthermore, the linear motion of the double parallelogram mechanism (102) after completion of the circular motion may lead to follow the linear trajectory in second stage of the cranking motion. Moreover, the circular motion may be configured to align a central axis (117) of the tray (110) with the axis (116) of the hollow tube (114) in an alignment position (3000). Furthermore, the linear motion may be configured to linearly move the tray (110) along with the axis (116) of the hollow tube (114) to obtain a loading position (4000). More specifically, the linear motion of the tray may load the article within the hollow tube (114).

In yet another embodiment, the double parallelogram mechanism (102) may include the first set of links (104). Further, the first set of links (104) may include a first binary link (104a), a second binary link (104b), a third binary link (104c), and a fourth binary link (104d) forming a parallelogram mechanism. Also, each of the first binary link (104a), the second binary link (104b), the third binary link (104c), and the fourth binary link (104d) are mechanically connected to each other. In some examples, these mechanical connections may include pivots, bearings, gears, ball joints, swivel joints, rotary joints, rotating bushings, and the like. In some embodiments, these mechanical connections may be any suitable mechanical means.

Furthermore, the double parallelogram mechanism (102) may include the second set of links (106). Moreover, the second set of links (106) may include a first curved link (106a), a second curved link (106b), the crank pin (106c) as third curved link, and a ground link. Also, the ground link may correspond to a link formed by fix ends of the first curved link (106a), the second curved link (106b), and the crank pin (106c) respectively of the second set of links (106). In general, ground link typically refers to a component in a mechanical system that serves as a fixed reference point or base for other moving parts. In an embodiment of the present disclosure, the first set of links (104) may be configured to couple with the tray (110). More specifically, the second binary link (104b) of the first set of links (104) may be coupled to the tray (110). Further, the second set of links (106) may be configured to couple with the actuator (112) of the article loading system (100). Furthermore, the crank pin (106c) as third curved link of the second set of links (106) may be coupled with a rack (118) of the actuator (112).

In one aspect, at least one of the first curved link (106a), the second curved link (106b), and the crank pin (106c) as the third curved link may include a curved shape not limited L-shape, V-shape, U-shape, arc-shape, or any combination thereof. Further, at least one of the first curved link (106a), the second curved link (106b), and the crank pin (106c) as the third curved link may be provided with a slot to reduce overall weight. Moreover, the pinion (108) attached to at least one end of the crank pin (106c) may be placed at a centre position between the first curved link (106a), and the second curved link (106b). Further, the centre position of the pinion (108) is provided at an equal offset distance from the first curved link (106a), and the second curved link (106b).

In some embodiments, the first set of links (104) and the second set of links (106) may be coupled together to form the double parallelogram mechanism (102). More particularly, at least one end of the first curved link (106a) may be connected to a middle portion of the first binary link (104a). Further, at least one end the second curved link (106b) may be connected to a middle portion of the fourth binary link (104d). Furthermore, at least one end of the crank pin (106c) as the third curved link may be connected to a middle portion of the third binary link (104c). Further, the fix end of each of the first curved link (106a), and the second curved link (106b) may be connected by a fifth link (124). In some embodiments, the fifth link (124) may be stationary. Furthermore, at least one end of the crank pin (106c) may be provided with the pinion (108) configured to engage with the rack (118) of the actuator (112) to drive the double parallelogram mechanism (102).

In some example embodiments, the pinion (108) may be rotated in clockwise, and anti-clockwise direction by the actuator (112). Further, the pinion (108) may rotate in the clockwise direction on forward movement (F) of the actuator (112). Furthermore, the pinion (108) may rotate in the anti-clockwise direction on rearward movement (R) of the actuator (112). Further, the rotation of the pinion (108) in the clockwise direction may facilitate clockwise cranking motion of the crank pin (106c). Furthermore, the rotation of the pinion (108) in the anti-clockwise direction may facilitate the anti-clockwise cranking motion of the crank pin (106c). Additionally, the actuator (112) may include a rack (118). Further, the rack (118) may be configured to engage with the pinion (108) connected to the crank pin (106c). More specifically, the forward movement (F) of the actuator (112) may be transferred by the rack (118) to the pinion (108) resulting the clockwise motion. In some examples, the forward movement (F) may refer to a motion of the tray (110) towards the hollow tube (114). Further, the rearward movement (R) of the actuator (112) may be transferred by the rack (118) to the pinion (108) resulting the anti-clockwise motion. In some examples, the rearward movement (R) may refer to a motion of the tray (110) away from the hollow tube (114).

In yet another example embodiment, the actuator (112) may include at least one of hydraulic actuator, pneumatic actuator, electrical actuator, or any combination thereof. Further, the actuator (112) may be mounted on the platform (126). Furthermore, the actuator (112) may be mounted on the platform (126) in at least one of fixed, or detachable manner. Further, the actuator (112) may be provided with a reciprocating rod. Furthermore, the reciprocating rod may be provided with plurality of teeth forming the rack (118). Further, the rack (118) may remain in continuous engagement with the pinion (108). Further, a central axis of the pinion (108) and a centre axis of the actuator (112) may be arranged perpendicular to each other. Additionally, the actuator (112) and the pinion may be enclosed within a common casing.

In yet another example embodiment, the tray (110) may include a conical ring (120) at front portion (110a). Further, the conical ring (120) may be provided to be secure with an conical opening (114a) of the hollow tube (114). Furthermore, the conical opening (114a) of the hollow tube (114) may include a tapered receiving part. Further, the tapered receiving part may include an equivalent taper shape with respect to the corresponding shape of the conical ring (120). Furthermore, the cross-sectional shape of the conical opening (114a) may include but not limited to a circular, a rectangular, a triangular, or any other shape. Further, the linear motion of the tray (110) may facilitate securing of the conical ring (120) with the conical opening (114a). Moreover, the engagement between the conical ring (120) and the tapered receiving part of the conical opening (114a) may ensure a smooth movement of the article from the tray (110) into the hollow tube (114).

In yet another example embodiment, the article loading system (100) may be provided with a ramming actuator. Further, the ramming actuator may be mounted on a plate (122). Furthermore, the ramming actuator may be connected to the rear portion of the tray (110). Further, the rear portion of the tray (110) may be provided with a stopper. Furthermore, the stopper may be provided to hold the article placed within the tray (110) from rear side. Moreover, the ramming actuator may be facilitated to load the article to the hollow tube (114) by displacing the stopper by a ramming action. More specifically, the ramming action of the ramming actuator may move the article aligned with the axis (116) into the hollow tube (114) after completion of the movement of the double parallelogram mechanism (102).

In yet another example embodiment, the article loading mechanism (100) may be used in various industrial applications, and domestic applications. Further, the applications of the article loading mechanism (100) may include but not limited to a material handling robot, an assembly line equipment, a food or consumer product processing machinery, a pharmaceutical machinery, a construction material handling application, a projectile launching application, a warehouse material handling application, a transport vehicle part, and various loading-unloading application, or combination thereof.

Technical advantages and economic significance of the article loading system (100) includes but may not be limited to:
A combination of circular, and linear motion of the double parallelogram mechanism (102) within the single cranking motion. This dual functionality enables efficient movement of the tray (110), and loading operation of the article compared to the conventional design.
The loading operation facilitated by the linear motion of the tray (110) achieves precise loading of the article into the hollow tube (114) without any failure in alignment. Therefore, wear or breakdown of the tray (110) and hollow tube (114) due to collision by misalignment is prevented.
An arrangement of the actuator (112) in connection with the pinion (108) of the crank pin (106c) eliminates the complex and inefficient arrangement present in traditional systems. Further, the present arrangement ensures efficient power transfer, and smoother rotation by eliminating the mechanical failure.
The article loading system (100) structurally benefits due to the use of lighter links such as binary and curved links in the double parallelogram mechanism (102). These design improvements reduce the overall weight of the system, making it easier to maintain and improving operational efficiency.
The design of the article loading system (100) facilitates operation or working within compact, and constrained space.
A simple arrangement of the linkages of the double parallelogram mechanism (102) leads to reduced maintenance, or repair cost.
A curved shape of the first curved link (106a), the second curved link (106b), and the crank pin (106c) as the third curved link avoids overlapping between the first set of links (104) and the second set of links (106).

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the scope of the present disclosure as defined by the following claims, and equivalents thereof.

1. An article loading system, comprising:
a double parallelogram mechanism configured to obtain a circular motion and subsequently a linear motion, wherein the double parallelogram mechanism comprises a first set of links and a second set of links;
a crank pin of the second set of links is configured to drive the double parallelogram mechanism, wherein the circular motion and subsequently the linear motion of the double parallelogram mechanism is obtained in single cranking motion of the crank pin, wherein the cranking motion of the crank pin is facilitated by a pinion which is mechanically connected to the crank pin;
a tray configured to hold an article, wherein the tray is attached to at least one link of the first set of links; and
an actuator configured to rotate the pinion, wherein the rotation of the pinion facilitates the cranking motion of the crank pin to drive the double parallelogram mechanism.

2. The article loading system as claimed in claim 1, wherein the double parallelogram mechanism is configured to load the article within the tray into a hollow tube, wherein the article is loaded inline with an axis of the hollow tube.

3. The article loading system as claimed in claim 1, wherein the double parallelogram mechanism is configured to obtain the circular motion in first stage of the cranking motion to align a central axis of the tray with the axis of the hollow tube, following a circular trajectory.

4. The article loading system as claimed in claim 1, wherein the double parallelogram mechanism is configured to obtain the linear motion in second stage of the cranking motion to linearly move the tray inline with the axis of the hollow tube, following a linear trajectory.

5. The article loading system as claimed in claim 1, wherein the first set of links comprises a first binary link, a second binary link, a third binary link, and a fourth binary link forming a parallelogram mechanism, wherein each of the first binary link, the second binary link, the third binary link, and the fourth binary link are mechanically connected to each other.

6. The article loading system as claimed in claim 1, wherein the second set of links comprises a first curved link, a second curved link, the crank pin as a third curved link, and a ground link, wherein the ground link corresponds to a link formed by fix ends of the first curved link, the second curved link, and the crank pin respectively.

7. The article loading system as claimed in claim 5, wherein the tray is coupled to the second binary link of the first set of links.

8. The article loading system as claimed in claim 6, wherein the fix ends of the first curved link, the second curved link are connected by a fifth link.

9. The article loading system as claimed in claim 1, wherein the pinion is placed at a centre position between the first curved link, and the second curved link, wherein the centre position of the pinion is provided at an equal offset distance from the first curved link, and the second curved link.

10. The article loading system as claimed in claim 6, wherein the first curved link is connected to the first binary link, wherein the second curved link is connected to the fourth binary link, wherein at least one end of the crank pin as the third curved link is connected to the third binary link, wherein at least one end of the crank pin is provided with the pinion configured to drive the double parallelogram mechanism.

11. The article loading system as claimed in claim 1, wherein the pinion is rotated in a clockwise direction and an anti-clockwise direction by the actuator, wherein the pinion rotates in the clockwise direction on a forward movement (F) of the actuator, wherein the pinion rotates in the anti-clockwise direction on a rearward movement (R) of the actuator, wherein the rotation of the pinion in the clockwise direction and the anti-clockwise direction facilitates the cranking motion of the crank pin in the clockwise and anti-clockwise direction.

12. The article loading system as claimed in claim 11, wherein the actuator comprises a rack, wherein the rack is configured to engage with the pinion, wherein the forward movement (F) and the rearward movement (R) of the actuator is transferred by the rack to the pinion, wherein the pinion is rotated in the clockwise and the anti-clockwise direction with the forward movement (F) and the rearward movement (R) respectively.

13. The article loading system as claimed in claim 1, wherein the actuator may include at least one of hydraulic actuator, pneumatic actuator, electrical actuator, or any combination thereof.

14. The article loading system as claimed in claim 1, wherein the tray comprises a conical ring at front portion, wherein the conical ring is adapted to be placed securely against an conical opening of the hollow tube, wherein the linear motion of the tray facilitates concentric securing of the conical ring with the axis of the hollow tube at the conical opening.

15. The article loading system as claimed in claim 1, wherein a ramming actuator is provided at the rear portion of the tray, wherein the rear portion of the tray is provided with a stopper, wherein the stopper is configured to hold the article placed within the tray from rear side, wherein the ramming actuator is configured to load the article to the hollow tube by displacing the stopper.
